(19) United States
(12) Patent Application Publication
(10) Pub. No.: US 2009/0055462 A1
(43) Pub. Date: Feb. 26, 2009

(54) SUB-CONTENT DISTRIBUTING SYSTEM AND SUB-CONTENT DISTRIBUTING METHOD USING THE SYSTEM

(75) Inventors: Daisuke Mori, Tokyo (JP); Shinichi Ide, Tokyo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/994,705

(22) PCT Filed: Feb. 8, 2006
(86) PCT No.: PCT/JP2006/302131

§ 371 Date: Jan. 4, 2008

(30) Foreign Application Priority Data
Jul. 7, 2005 (JP) 2005-198198

(51) Int. Cl. G06F 15/16

(52) U.S. Cl. 709/201

(57) ABSTRACT

A system in which broadcast receiving terminals receives a broadcast and the broadcast program sub-content data list, a sub-content distributing device sends a waiting time to each user even if many accesses deluge, and the broadcast receiving terminals can automatically download the sub-content after the waiting time has passed without making a re-access. The sub-content distributing system comprises a broadcasting device, a sub-content distributing device, and broadcast receiving terminals. The broadcast receiving terminals each have means for transmitting sub-content request information according to identification information included in the received sub-content list data and acquiring sub-content transmission foreforenotice information. The sub-content distributing device has means for computing a sub-content transmission schedule according to the amount of request information transmitted from broadcast receiving terminals and transmitting transmission foreforenotice information according to the computed transmission schedule to the broadcast receiving terminals.

### BACKGROUND OF THE INVENTION

1. Field of the Invention

The present invention relates to a sub-content distribution system, comprising a broadcasting apparatus, which broadcasts main content relating to sub-content, a distribution apparatus for sub-content, which distributes sub-content, and a receiving terminal apparatus for broadcast, and a sub-content distribution method utilizing the system.

2. Description of the Related Art

Recently, a system for distribution service, in which a server for distributing content such as music is accessed from a terminal device such as a mobile phone, an entire music etc. desired by a user of the terminal device is downloaded, has become widely used. For example, in Japanese Unexamined Patent Application Publication No. 2005-135008, an information distribution system for downloading and distributing content of image and music etc. from a content distribution apparatus to an information terminal via a network. is disclosed. Further, in Japanese Unexamined Patent Application Publication No. 2004-054675, an apparatus, in which music data etc. desired by a user is acquired from a server for information service, is disclosed.

In recent years, specifically, since users desire to instantaneously download their favorite songs from songs broadcasted in a music TV program etc., a distribution server is flooded with accesses for downloading songs broadcasted in the current program immediately after or during broadcast of the program. However, the conventional distribution system requires users to search for information for downloading the song such as a title for specifying the song, data of the artist, or identifier information of a server capable of downloading the song, thereby causing inconveniences to the users. Further, if a huge number of accesses come, it becomes necessary for the user to access the server many times. Further, waiting time for downloads is not notified, so that the user unnecessarily repeats accesses while a huge number of accesses continue to be received, thereby further inconveniencing the user.

In order to solve the above deficiencies, although a system for transmitting waiting time is disclosed, in this case, the user still have to unnecessarily access again in order to download after the waiting time elapses. Therefore, it remains inconvenient for the user.

### SUMMARY OF THE INVENTION

It is an objective of the present invention to provide the sub-content distribution system, in which it becomes possible to receive a data list regarding sub-content of a currently broadcasted program upon receiving the broadcast program. Moreover, even if a huge number of accesses come, it becomes possible to notify a user of waiting time, and to automatically download the sub-content without re-accessing after the waiting time elapses.

In order to solve the above deficiencies, the present invention provides a sub-content distribution system, comprising, a broadcasting apparatus, which broadcasts main content relating to sub-content, a distribution apparatus for sub-content, which distributes sub-content, and a receiving terminal apparatus for broadcast, wherein the broadcasting apparatus comprises, a broadcasting unit for sub-content list data, which broadcasts sub-content list data including identification information of sub-content, the receiving terminal apparatus for broadcast comprises, a transmission unit for request information of sub-content, which transmits request information of sub-content based on the identification information of sub-content included in the received sub-content list data, and an acquisition unit for transmission forenotice information of sub-content, which acquires transmission forenotice information of sub-content in accordance with the request information of sub-content transmitted from the transmission unit for request information of sub-content, and the distribution apparatus for sub-content comprises, a calculation unit for transmission schedule of sub-content, which calculates a transmission schedule of sub-content based on amount of the request information of sub-content transmitted from a plurality of receiving terminal apparatuses for broadcast, and a transmission unit for transmission forenotice information of sub-content, which transmits the transmission forenotice information of sub-content generated based on the calculated transmission schedule of sub-content to the receiving terminal apparatus for broadcast, which has transmitted the request information of sub-content.

According to the sub-content distribution system of the present invention, it becomes possible to receive the data list regarding sub-content of currently broadcasted program upon receiving the broadcast program. Moreover, even if a huge number of accesses come, it becomes possible to notify a user of waiting time, and to automatically download the sub-content without re-accessing after the waiting time elapses.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a functional block diagram exemplifying a distribution system for sub-content of a first embodiment;

FIG. 2 is a conceptual diagram showing a concrete example of the distribution system for sub-content of the first embodiment;

FIG. 3 is a diagram exemplifying acquisition of information regarding distribution of sub-content in the distribution system for sub-content of the first embodiment;

FIG. 4 is a flow chart of the distribution system for sub-content of the first embodiment;

FIG. 5 is a functional block diagram exemplifying a distribution system for sub-content of a second embodiment;

FIG. 6 is a diagram exemplifying acquisition of information regarding distribution of sub-content in the distribution system for sub-content of the second embodiment;

FIG. 7 is a functional block diagram exemplifying a distribution system for sub-content of a third embodiment;

FIG. 8 is a diagram exemplifying acquisition of information regarding distribution of sub-content in the distribution system for sub-content of the third embodiment;

FIG. 9 is a functional block diagram exemplifying a distribution system for sub-content of a fourth embodiment;

FIG. 10 is a diagram exemplifying acquisition of information regarding distribution of sub-content in the distribution system for sub-content of the fourth embodiment;

FIG. 11 is a functional block diagram exemplifying a distribution system for sub-content of a fifth embodiment; and

FIG. 12 is a diagram exemplifying acquisition of information regarding distribution of sub-content in the distribution system for sub-content of the fifth embodiment.

### DETAILED DESCRIPTION OF THE PREFERRED EMBODIMENTS

Hereinbelow, embodiments of the present invention will be described. The present invention is not to be limited by the disclosed embodiments, and may be embodied in various forms without departing from the scope of the invention.

### First embodiment

<Concept>

A sub-content distribution system of a first embodiment comprises a broadcasting apparatus, a distribution apparatus for sub-content, which distributes sub-content, and a receiving terminal apparatus for broadcast. Specifically, in the system of the first embodiment, the distribution apparatus for sub-content calculates a transmission schedule of sub-content based on amount of the request information of sub-content transmitted from a plurality of receiving terminal apparatuses for broadcast, and transmits the transmission forenotice information of sub-content generated based on the calculated transmission schedule of sub-content to the receiving terminal apparatus for broadcast.

<Configuration>

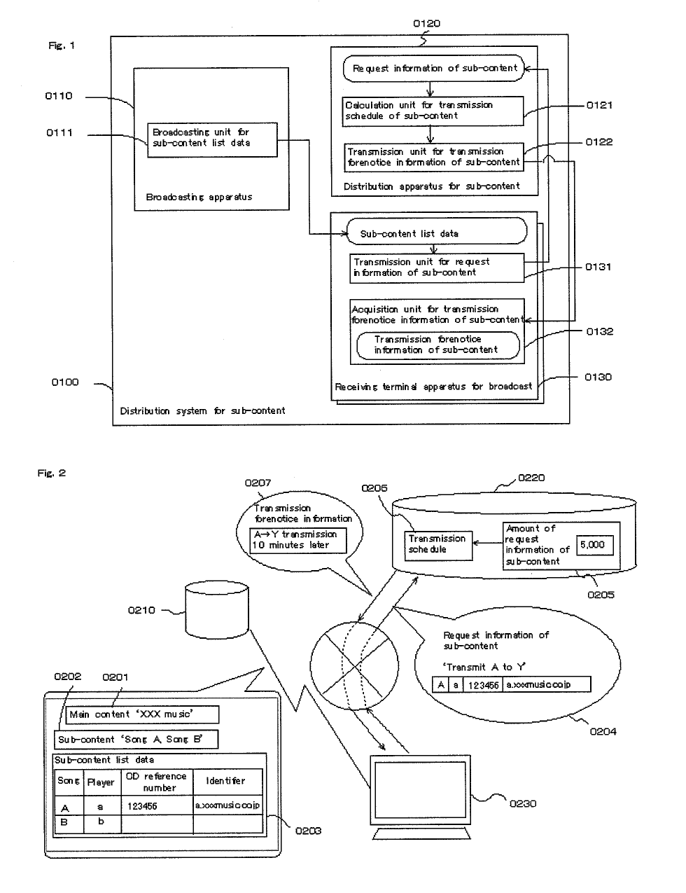

FIG. 1 is a functional block diagram exemplifying a distribution system for sub-content of a first embodiment.

The respective units of the present invention are configured by hardware, software, or both hardware and software. For example, in the case of using a computer, the respective units are implemented by the hardware configured by a CPU, a memory, a bus, an interface, and other peripheral devices etc., and by the software operable on the hardware.

Concretely speaking, by sequentially carrying out programs on the memory, the data on the memory and the data inputted via the interface are processed, stored, and outputted etc., thereby implementing functions of the respective units.

In FIG. 1, a ‘sub-content distribution system’ 0100 of a first embodiment comprises a ‘broadcasting apparatus’ 0110, a ‘distribution apparatus for sub-content’ 0120, and a ‘receiving terminal apparatus for broadcast’ 0130.

The ‘broadcasting apparatus’ is configured to broadcast main content relating to sub-content, and comprises a ‘broadcasting unit for sub-content list data’ 0111. The ‘sub-content’ is an object to be downloaded from the distribution apparatus for sub-content in the system of the first embodiment. This sub-content is broadcasted during broadcast of a program as the ‘main content’. For example, in the case of music program, the program titled as ‘XXX music’ corresponds to the main content, and respective songs (e.g., song A) corresponds to the sub-content. Therefore, the ‘main content’ corresponds to a program broadcasted by the broadcasting apparatus. Note that the sub-content is not necessarily included in the main content, and it is enough that relation between them exists. For example, in cases where the song A is performed live in the main content ‘XXX music’, the sub-content may be sound source of the same song A preliminarily recorded in a CD. Note that the ‘broadcast’ may include both wireless and wired broadcastings. Further, the content to be broadcasted may include only sound information, or may include image information etc. in addition to the sound information.

The ‘broadcasting unit for sub-content list data’ is configured to broadcast sub-content list data including identification information of sub-content. The ‘identification information of sub-content’ is information for uniquely identifying sub-content. Examples of the sub-content include title for identifying respective songs, artist, or CD reference number.

The ‘sub-content list data’ is information indicating a list of (specifically, a plurality of) sub-content identification information. For example, this sub-content list data may be a portion of data included in digital broadcast. Further, in this case, in the sub-content list data may be inserted during broadcast in BML format. Further, it is preferable that the sub-content list data is broadcasted in the same band as that of the main content relating to the sub-content. (Further, it is preferable that the sub-content is also broadcasted in the same band as that of the main content if the sub-content identified by the sub-content identification information is included in the main content.) Note that data amount of the sub-content list data is far smaller than that of sub-content (preferably, within 10 k bytes). The reason for this is the feature of the data, of which list data is preliminarily broadcasted in place of the sub-content, having a certain data amount and requiring long transmission time.

The ‘receiving terminal apparatus for broadcast’ comprises a ‘transmission unit for request information of sub-content’ 0131, and an ‘acquisition unit for transmission forenotice information of sub-content’ 0132.

The ‘transmission unit for request information of sub-content’ transmits request information of sub-content based on the identification information of sub-content included in the received sub-content list data. The ‘request information of sub-content’ is information for requesting transmission of sub-content (e.g., information including an instruction to ‘transmit song A to a terminal identified by identifier B’). Note that a destination of this information is no object (e.g., broadcasting apparatus).

The ‘acquisition unit for transmission forenotice information of sub-content’ is configured to acquire transmission forenotice information of sub-content in accordance with the request information of sub-content transmitted from the transmission unit for request information of sub-content. The ‘transmission forenotice information of sub-content’ is information for notifying transmission of sub-content, and necessarily includes information indicating forenotice itself, and preferably includes information indicating estimated time of transmission (or waiting time until transmission). For example, information indicating that ‘song A will be transmitted in 10 minutes’ corresponds to the information.

The ‘distribution apparatus for sub-content’ comprises a ‘calculation unit for transmission schedule of sub-content’ 0121, and a ‘transmission unit for transmission forenotice information of sub-content’ 0122.

The ‘calculation unit for transmission schedule of sub-content’ is configured to calculate a transmission schedule of sub-content based on amount of the request information of sub-content transmitted from a plurality of receiving terminal apparatuses for broadcast. For example, in this calculation, amount of the request information of sub-content is acquired based on number of accesses, and based on this, order and timing of transmission of the sub-content corresponding to the respective request information of sub-content are calculated. In this case, this transmission schedule may be calculated based on magnitude of data amount of the requested sub-content other than the order of request. For example, in order to distribute sub-contents to as many receiving terminal apparatuses for broadcast in a short time as possible, the schedule is calculated, so that distribution is carried out in ascending order of data amount.

The ‘transmission unit for transmission forenotice information of sub-content’ is configured to transmit the transmission forenotice information of sub-content generated based on the calculated transmission schedule of sub-content to the receiving terminal apparatus for broadcast, which has transmitted the request information of sub-content.

FIG. 2 is a conceptual diagram showing a concrete example of the distribution system for sub-content of the first embodiment. In FIG. 2, the broadcasting apparatus is a server of X broadcast station, the distribution apparatus for sub-content is a server of list provider, and the receiving terminal apparatus for broadcast is a TV terminal having internet function owned by a user (viewer). Further, the main content is a program titled as ‘XXX music’, and the sub-content is song A broadcasted in this program. Further, FIG. 2 shows that a user watches this program, and downloads his favorite song A, broadcasted in the program, to the user's receiving terminal apparatus for broadcast Y. In this case, the broadcasting apparatus 0210 broadcasts the list data 0203 of the song to be a sub-content, which is planned to be broadcasted (or already broadcasted) in the current program, during broadcast of the current program or immediately after broadcast of the current program with the main content 0201 and the sub-content 0202, and the receiving terminal apparatus for broadcast Y 0230 receives the data. This list includes information indicating title, artist, CD reference number, and identifier of server to be accessed etc. with respect to each song. In FIG. 2, this information includes ‘Song name A, Artist name A, CD reference number 123456, and Identifier http://www.a.xxxmusic.co.jp’. Subsequently, the receiving terminal apparatus for broadcast Y selects information regarding the song A from the list data, and transmits it as the request information of sub-content 0204 with an instruction to transmit the song to the apparatus (terminal Y) to the distribution apparatus for sub-content 0220, a transmission destination specified by an identifier of the song. The identifier can widely include numerical string or string etc. indicating address of a server to be accessed with regard to the song. Alternatively, the identifier may be for identifying address of a file to be accessed in the same server (e.g., http://www.a.xxxmusic.co.jp/filea), not for identifying the server. Generally, the distribution apparatus for sub-content receives from the request information of sub-content from the other receiving terminal apparatuses for broadcast. In this case, the apparatus calculates a transmission schedule of sub-content 0206 based on amount of the request information of sub-content 0205 transmitted from a plurality of receiving terminal apparatuses for broadcast. FIG. 2 shows that huge number of accesses (transmissions of the request information of sub-content) are received immediately after broadcast of the current program, and an access from the receiving terminal apparatus for broadcast Y is the 500th access. The distribution apparatus for sub-content calculates order and timing of transmission of the sub-content corresponding to the respective accesses as a transmission schedule of sub-content based on the 5,000 accesses, the amount of request information of sub-content. In this calculation, a schedule indicating that transmission of sub-content corresponding to the access from Y is carried out in 10 minutes is calculated. Further, the distribution apparatus for sub-content transmits the transmission forenotice information 0207 indicating that ‘transmission of A to Y is carried in 10 minutes’ to the receiving terminal apparatus for broadcast.

In the above case, the receiving terminal apparatuses for broadcast may be configured to transmit identification information of apparatus, which is for uniquely identifying the apparatus itself, with the request information of sub-content, and the distribution apparatus for sub-content may be configured to transmit the transmission forenotice information of sub-content to the receiving terminal apparatuses for broadcast in cases where the receiving terminal apparatuses for broadcast is authenticated based on the identification information of apparatus. Further, in this case, the receiving terminal apparatuses for broadcast may be configured to transmit the other identification information with the identification information for apparatus. The other identification information includes, for example, user's address, postal code, name, age, and gender. This configuration is for enabling transmission of the transmission forenotice information of sub-content only to specific receiving terminal apparatuses for broadcast such as a receiving terminal apparatus for broadcast, which has been preliminarily registered. This makes it possible, for example, to transmit information to distinguish a dues-paying member and a free member as the other identification information, thereby setting differences regarding transmission of the transmission forenotice information of sub-content in accordance with priority of user based on the user's attribute of the terminal apparatus. Further, by transmitting the postal code along with the identification information for apparatus, it becomes possible to manage amount of request information of sub-content with respect to each area, thereby enabling calculation of transmission schedule and transmission of transmission forenotice information of sub-content with respect to each area.

Subsequently, the distribution apparatus for sub-content may distribute the sub-content to the receiving terminal apparatuses for broadcast. In this case, it is configured that the distribution is carried out in accordance with the transmission schedule calculated as above. Further, although the above distribution of sub-content may be based on the request information of sub-content re-transmitted from the receiving terminal apparatuses for broadcast in 10 minutes, preferably it is not based on it. In the latter case, means for distributing sub-content is configured to distribute the sub-content to the receiving terminal apparatuses for broadcast in cases where the information, indicating that the time specified by the transmission schedule has come, is acquired (i.e., automatic download is carried out). Therefore, it becomes possible for a user to estimate the time of the distribution of the requested sub-content, and to await the automatic download.

The hardware configuration of the system of the first embodiment is as follows. For example, the system of the first embodiment is configured to generate one data from data transmitted by the transmission means for main content, by the transmission means for sub-content, and by the transmission means for sub-content list data in multiplexing means of the broadcasting apparatus, and to broadcast the data in the same band. Further, in receiving means such as a tuner of the receiving terminal apparatuses for broadcast, the above data is received from the broadcasting apparatus. Subsequently, the acquired data is stored in a memory (including external storage device. hereinbelow, the same applies.), and if CPU determines that a signal indicating selection of the identification information of sub-content included in the sub-content list data by the user exists, in accordance with an instruction from a control program in a main memory, request information of sub-content as to the sub-content including the above identification data for sub-content is generated by the CPU, and it is transmitted from the receiving terminal apparatuses for broadcast to the distribution apparatus for sub-content via the communication interface. Further, in the system of the first embodiment, the amount of the request information of sub-content is detected, and the latest condition is stored in a memory and is updated, so that in accordance with the instruction of the control program in the main memory, the transmission schedule of sub-content is calculated by the CPU based on the amount of request information of sub-content. Qualitatively, it is programmed that in the case of a large amount of requests, the requests are processed over a long time, and in the case of small amount of the requests, the requests are processed in a short time. It is convenient that some types of schedules are prepared in the memory in accordance with the amount of requests, and the schedule program may be appropriately selected in accordance with the amount of requests stored in the memory, or the schedule may be generated by giving the amount of requests as a parameter to a program for generating the schedule program, which is preliminarily prepared in the memory. Note that configuration of the schedule depends on design. Further, in the system of the first embodiment, the transmission schedule acquired from a result of the calculation is stored in the memory, and based on the transmission schedule read from the memory, the transmission forenotice information of sub-content generated by the predetermined generation program for transmission forenotice information stored in the memory is transmitted from the distribution apparatus for sub-content to the receiving terminal apparatuses for broadcast via the communication interface. Note that the above-mentioned CPU, main memory, memory, communication interface, and external storage device are connected to bus line.

<Processing Flow>

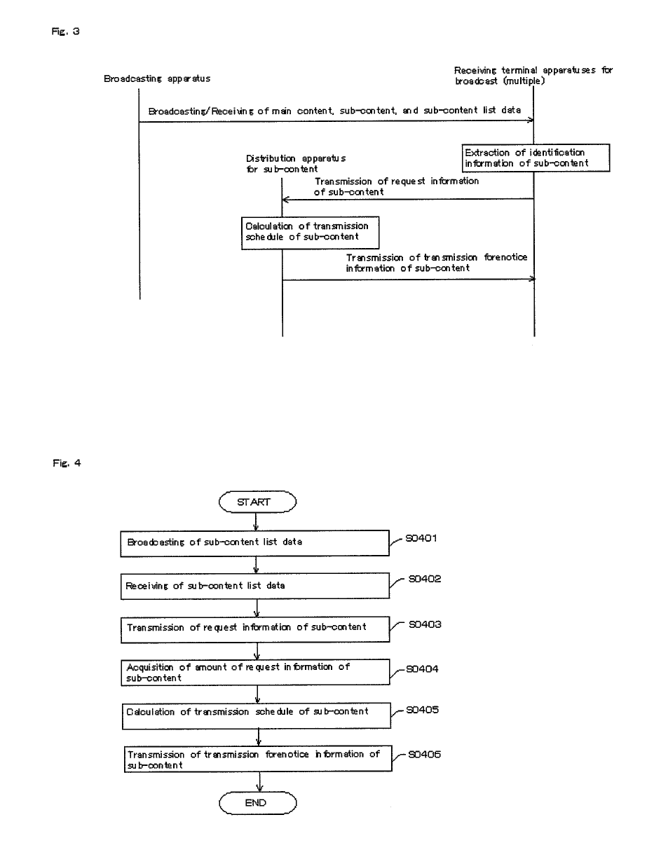

FIG. 3 is a diagram exemplifying acquisition of information regarding distribution of sub-content in the distribution system for sub-content of the first embodiment. In FIG. 3, the main content, sub-content, and sub-content list data, broadcasted by the broadcasting apparatus, are received by the receiving terminal apparatuses for broadcast. Subsequently, the identification information of sub-content as to the sub-content, which user desires to download, is extracted from the sub-content list data received by the receiving terminal apparatuses for broadcast. Thereafter, the receiving terminal apparatus for broadcast transmits the request information of sub-content regarding the sub-content to the distribution apparatus for sub-content. The distribution apparatus for sub-content calculates the transmission schedule of sub-content based on the amount of requests transmitted from the receiving terminal apparatuses for broadcast, and transmits the transmission forenotice information of sub-content to the receiving terminal apparatuses for broadcast based on the schedule.

FIG. 4 is a flow chart of the distribution system for sub-content of the first embodiment. In FIG. 4, the processing includes the following steps.

At the outset, in the step of broadcasting of sub-content list data S0401, the distribution system for sub-content of the first embodiment broadcasts the sub-content list data including the identification information of sub-content.

Subsequently, in the step of receiving of sub-content list data S0402, the distribution system for sub-content of the first embodiment receives the sub-content list data, which has been broadcasted in the step of broadcasting of sub-content list data.

Subsequently, in the step of transmitting request information of sub-content S0403, the distribution system for sub-content of the first embodiment transmits the request information of sub-content from a plurality of receiving terminal apparatuses for broadcast based on the identification information of sub-content included in the sub-content list data received in the step of receiving of sub-content list data.

Subsequently, in the step of acquiring amount of request information of sub-content S0404, the distribution system for sub-content of the first embodiment acquires transmission forenotice information of sub-content in accordance with the request information of sub-content transmitted in the step of transmitting request information of sub-content.

After that, in the step of calculating transmission schedule of sub-content S0405, the distribution system for sub-content of the first embodiment calculates a transmission schedule of sub-content based on amount of the request information of sub-content transmitted in the step of transmitting request information of sub-content.

Subsequently, in the step of transmitting transmission forenotice information of sub-content S0406, the distribution system for sub-content of the first embodiment transmits the transmission forenotice information of sub-content generated based on the transmission schedule of sub-content calculated in the step of calculating transmission schedule of sub-content to the receiving terminal apparatus for broadcast, which has transmitted the request information of sub-content.

<Brief Description of Effects of First Embodiment>

According to the distribution system for sub-content of the first embodiment, it becomes possible to receive the data list regarding sub-content of currently broadcasted program upon receiving the broadcast program. Moreover, even if a huge number of accesses are received, it becomes possible to automatically download the sub-content without re-accessing by a user after the waiting time elapses.

### Second Embodiment

<Concept>

The sub-content distribution system of the second embodiment is based on the first embodiment, and the distribution apparatus for sub-content further comprises a transmission unit for sub-content, which carries out transmission of sub-content based on the transmission schedule of sub-content.

<Configuration>

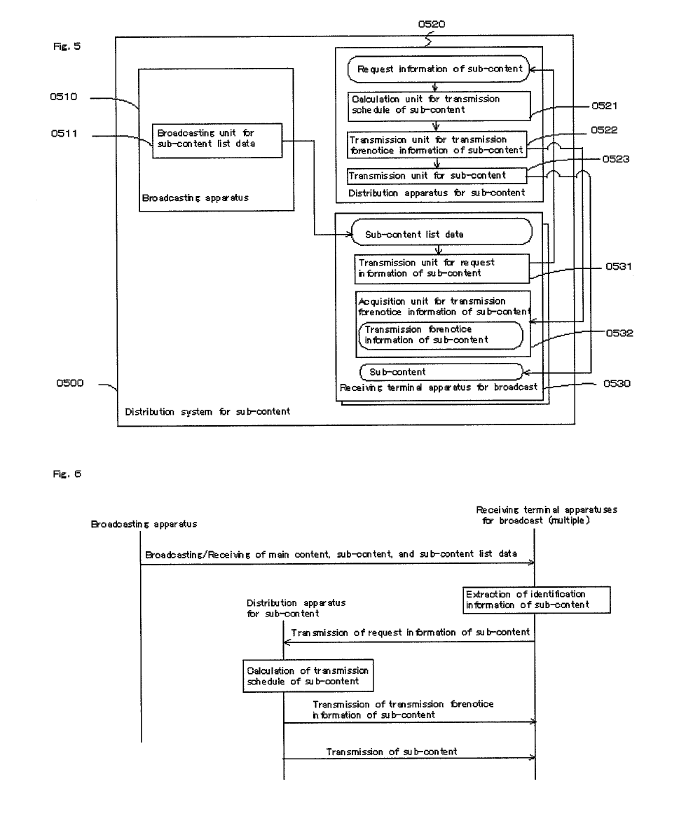

FIG. 5 is a functional block diagram exemplifying a distribution system for sub-content of a second embodiment. In FIG. 5, a ‘sub-content distribution system’ 0500 of the second embodiment comprises a ‘broadcasting apparatus’ 0510, a ‘distribution apparatus for sub-content’ 0520, and a ‘receiving terminal apparatus for broadcast’ 0530. The configurations thereof are basically the same as those of the sub-content distribution system of the first embodiment.

The ‘distribution apparatus for sub-content’ further comprises a ‘transmission unit for sub-content’ 0523. The ‘transmission unit for sub-content’ is configured to carry out transmission of sub-content based on the calculated transmission schedule of sub-content. For example, in cases where a schedule including that the transmission timing of the sub-content, song A, to the receiving terminal apparatus for broadcast Y is in 10 minutes is calculated, the transmission unit for sub-content transmits the song A to the receiving terminal apparatus for broadcast Y in 10 minutes.

The hardware configuration of the system of the second embodiment is basically the same as that of the first embodiment, and the system is further configured to transmit the sub-content from the sub-content distribution apparatus to the receiving terminal apparatus for broadcast via the communication interface.

The other configurations are the same as those of the sub-content distribution system of the first embodiment, so that descriptions are omitted.

<Processing Flow>

FIG. 6 is a diagram exemplifying acquisition of information regarding distribution of sub-content in the distribution system for sub-content of the second embodiment, and is basically the same as that in the sub-content distribution system of the first embodiment. In FIG. 6, the distribution system for sub-content carries out transmission of sub-content based on the transmission schedule of sub-content.

The other acquisitions are the same as those in the sub-content distribution system of the first embodiment, so that descriptions are omitted.

<Brief Description of Effects of Second Embodiment>

According to the distribution system for sub-content of the second embodiment, it becomes possible to carry out transmission for automatic downloading of the sub-content without re-accessing by a user after the waiting time elapses, even if a huge number of accesses come

### Third Embodiment

<Concept>

The sub-content distribution system of the third embodiment is based on the first or second embodiment, and the broadcasting unit for sub-content list data of the broadcasting apparatus further comprises broadcasting means during broadcast of program, which broadcasts sub-content list data during broadcast of main content, or immediately after the broadcast of main content, and the receiving terminal apparatus for broadcast further comprises an output unit for list during broadcast of program, which outputs a sub-content list data during output of main content, or immediately after the output of main content.

<Configuration>

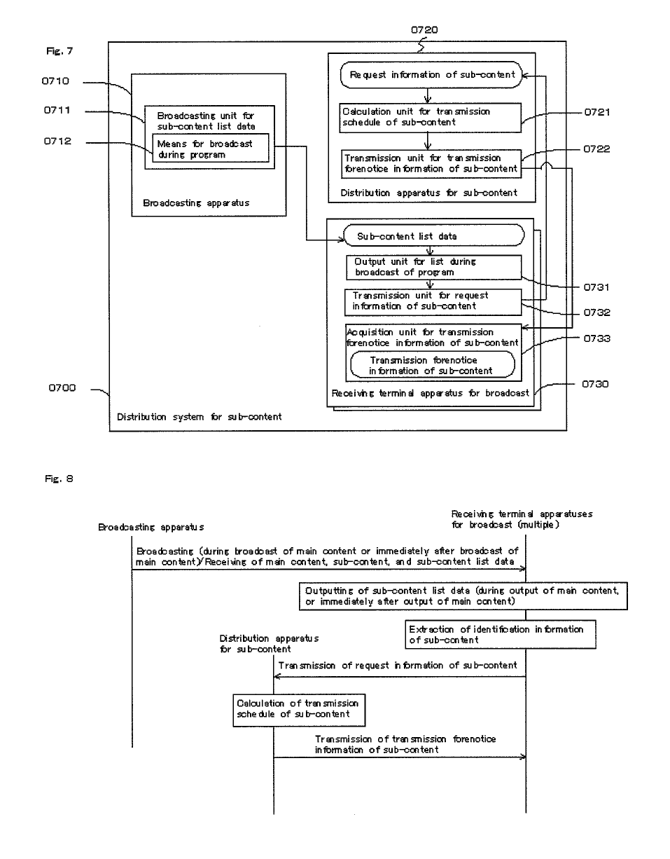

FIG. 7 is a functional block diagram exemplifying a distribution system for sub-content of a third embodiment. In FIG. 7, a ‘sub-content distribution system’ 0700 of the second embodiment comprises a ‘broadcasting apparatus’ 0710, a ‘distribution apparatus for sub-content’ 0720, and a ‘receiving terminal apparatus for broadcast’ 0730. The configurations thereof are basically the same as those of the sub-content distribution system of the first or second embodiment.

The ‘broadcasting unit for sub-content list data’ 0711 of the ‘broadcasting apparatus’ comprises ‘broadcasting means during broadcast of program’ 0712. The ‘broadcasting means during broadcast of program’ is configured to broadcast sub-content list data during broadcast of main content, or immediately after the broadcast of main content. Further, the ‘receiving terminal apparatus for broadcast’ further comprises an ‘output unit for list during broadcast of program’ 0731. The ‘output unit for list during broadcast of program’ is configured to output a sub-content list data during output of main content, or immediately after the output of main content.

The reason why the transmission is restricted during broadcast of main content, or immediately after the broadcast of main content is that the time zone, in which user who has watched the sub-content etc. broadcasted in the main content possibly desires to download the sub-content, is the best time to broadcast the list for the user. Therefore, the terms ‘immediately after the broadcast’ means the time zone, in which user who has watched the sub-content etc. broadcasted in the main content possibly desires to download the sub-content. Concretely speaking, the time is around 5 minutes before the next program starts. The reason why the output is restricted during broadcast of main content, or immediately after the broadcast of main content, and the meaning of the terms ‘immediately after the output’ are the same as the above.

There can be various patterns in which sub-content list data is broadcasted during broadcast of main content, and the sub-content list data is outputted during output of main content or immediately after the output of main content. For example, in cases where the main content is a music program ‘XXX music’, and song A, B and C are broadcasted in the program, sub-content list data of these three songs are broadcasted immediately before the end of the broadcast of the main content, and may be outputted during output of main content or immediately after the output of main content. Alternatively, the data of the three songs are broadcasted upon the end of broadcast of the third song, and the data may be outputted during output of main content or immediately after the output of main content. Alternatively, the data of the first song is broadcasted upon the end of broadcast of the first song, and may be immediately outputted, the data of the first and second songs are broadcasted upon the end of broadcast of the second song, and may be immediately outputted, and the data of the three songs are broadcasted upon the end of broadcast of the third song, and may be immediately outputted. Alternatively, the data of the three songs are broadcasted upon the start of broadcast of the main content, and the data of the first song may be outputted upon the end of broadcast of the first song, the data of the first and second songs may be outputted upon the end of broadcast of the second song, and the data of the three songs may be outputted upon the end of broadcast of the third song.

According to the above configuration, it becomes possible for a user to download sub-content immediately.

The hardware configuration of the system of the third embodiment is basically the same as that of the first or second embodiment, and according to the system, in the receiving terminal apparatus for broadcast, the sub-content list data, which has been received from the broadcasting apparatus, and has been stored in a memory, is outputted by a CPU in accordance with an instruction by a control program in the main memory. In this case, the control program monitors the end of the broadcast, and outputs the sub-content list data if the end of the broadcast is detected, thereby enabling output immediately after the broadcast.

The other configurations are the same as those of the sub-content distribution system of the first or second embodiment, so that descriptions are omitted.

<Processing Flow>

FIG. 8 is a diagram exemplifying acquisition of information regarding distribution of sub-content in the distribution system for sub-content of the third embodiment, and is basically the same as that in the sub-content distribution system of the first or second embodiment. In FIG. 8, the distribution system for sub-content carries out broadcast of sub-content list data during broadcast of main content, or immediately after the broadcast of main content, and the receiving terminal apparatus for broadcast receives it.

The other acquisitions are the same as those in the sub-content distribution system of the first embodiment, so that descriptions are omitted.

<Brief Description of Effects of Third Embodiment>

According to the above configuration, it becomes possible to provide a system enabling a user to immediately download sub-content.

### Fourth Embodiment

<Concept>

The sub-content distribution system of the fourth embodiment further comprises a transmission apparatus for sub-content list data, which is a substitute for the broadcasting unit for sub-content list data of the broadcasting apparatus in any one of the first to third embodiments, and transmits the sub-content list data to the receiving terminal apparatus for broadcast.

<Configuration>

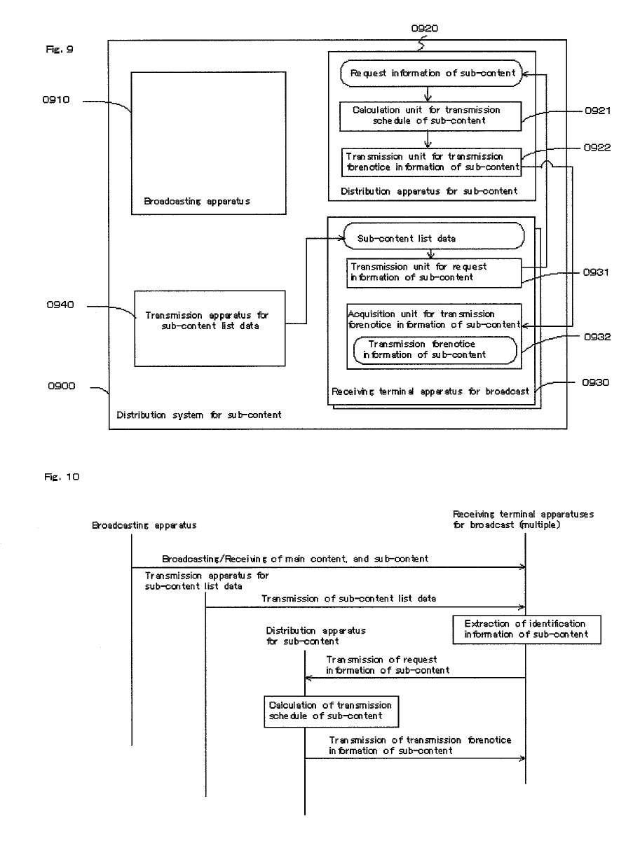

FIG. 9 is a functional block diagram exemplifying a distribution system for sub-content of a fourth embodiment. In FIG. 9, a ‘sub-content distribution system’ 0900 of the fourth embodiment comprises a ‘broadcasting apparatus’ 0910, a ‘distribution apparatus for sub-content’ 0920, a ‘receiving terminal apparatus for broadcast’ 0930, and a ‘transmission apparatus for sub-content list data’ 0940. The configurations thereof are basically the same as those of the sub-content distribution system in any one of the first to third embodiments.

The distribution system for sub-content of a fourth embodiment further comprises a transmission apparatus for sub-content list data as a substitute for the broadcasting unit for sub-content list data of the broadcasting apparatus. The ‘transmission apparatus for sub-content list data’ is configured to transmit the sub-content list data to the receiving terminal apparatus for broadcast. This configuration is for enabling transmission of the sub-content list data only to specific receiving terminal apparatuses for broadcast such as a receiving terminal apparatus for broadcast, which has been preliminarily registered, and setting of time difference between transmission to the above receiving terminal apparatuses for broadcast and transmission to the other receiving terminal apparatuses for broadcast. This makes it possible, for example, to set difference between the transmissions in accordance with priority of user based on the user attribute of the terminal apparatus such as a distinction between a dues-paying member and a free member.

Note that the hardware configuration of the system of the fourth embodiment is basically the same as that in any one of the first to third embodiments, and the system is further configured to transmit the sub-content list data from the transmission apparatus for sub-content list data to the receiving terminal apparatus for broadcast via the communication interface.

The other configurations are the same as those in the sub-content distribution system in any one of the first to third embodiments, so that descriptions are omitted.

<Processing Flow>

FIG. 10 is a diagram exemplifying acquisition of information regarding distribution of sub-content in the distribution system for sub-content of the fourth embodiment, and is basically the same as that in the sub-content distribution system in any one of the first to third embodiments. In FIG. 10, the transmission apparatus for sub-content list data carries out transmission of the sub-content list data as a substitute for the broadcast of the sub-content list data by the broadcasting apparatus, and the receiving terminal apparatus for broadcast receives it.

The other acquisitions are the same as those in the sub-content distribution system in any one of the first to third embodiments, so that descriptions are omitted.

<Brief Description of Effects of Fourth Embodiment>

According to the distribution system for sub-content of the fourth embodiment, it becomes possible to distribute the sub-content in accordance with priority of user.

### Fifth Embodiment

<Concept>

The sub-content distribution system of the fourth embodiment is based on the first to fourth embodiments, and further comprises a management apparatus for request information of sub-content list, comprising a receiving unit for request information of sub-content, which receives request information of sub-content from a plurality of receiving terminal apparatuses for broadcast, and a transmission unit for request condition information, which transmits request condition information including amount of the request information of sub-content received by the receiving unit for request information of sub-content.

<Configuration>

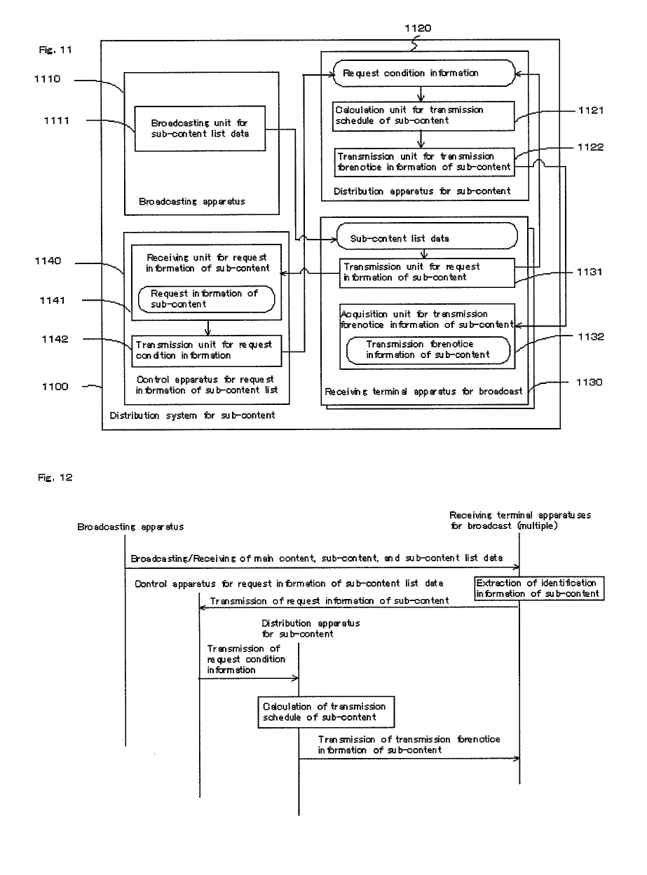

FIG. 11 is a functional block diagram exemplifying a distribution system for sub-content of the fifth embodiment. In FIG. 11, a ‘sub-content distribution system’ 1100 of the fifth embodiment comprises a ‘broadcasting apparatus’ 1110, a ‘distribution apparatus for sub-content’ 1120, a ‘receiving terminal apparatus for broadcast’ 1130, and a ‘management apparatus for request information of sub-content list’ 1140. The configurations thereof are basically the same as those of the sub-content distribution system in any one of the first to fourth embodiments.

The ‘management apparatus for request information of sub-content list’ comprises a ‘receiving unit for request information of sub-content’ 1141, and a ‘transmission unit for request condition information’ 1142. The ‘receiving unit for request information of sub-content’ is configured to receive request information of sub-content from a plurality of receiving terminal apparatuses for broadcast. The ‘transmission unit for request condition information’ is configured to transmit request condition information including amount of the request information of sub-content received by the receiving unit for request information of sub-content. The ‘request condition information’ may include, for example, order of requests, and magnitude of data amount of the requested sub-content. According to the above configuration, it becomes possible to separate the management function of the request information from the distribution apparatus for sub-content, and to cause a special apparatus to carry out the management, thereby reducing processing load of the distribution apparatus for sub-content, and enabling efficient management of the request information.

Additionally, although it is not indicated in FIG. 11, in the distribution system for sub-content of the fifth embodiment, the request information from the receiving terminal apparatus for broadcast may be transmitted not only to the management apparatus for request information of sub-content list, but also to the distribution apparatus for sub-content. This is for enabling the distribution apparatus for sub-content to promptly acquire the request information.

Note that the hardware configuration of the system of the fifth embodiment is basically the that in any one of the first to fourth embodiments, and according to the system, in the management apparatus for request information of sub-content list, the request information of sub-content list is received from a plurality of receiving terminal apparatuses for broadcast via the communication interface, and the request condition information including amount of the received request information of sub-content is transmitted from the management apparatus for request information of sub-content list to the distribution apparatus for sub-content via the communication interface.

The other configurations are the same as those in the sub-content distribution system in any one of the first to fourth embodiments, so that descriptions are omitted.

<Processing Flow>

FIG. 12 is a diagram exemplifying acquisition of information regarding distribution of sub-content in the distribution system for sub-content of the fifth embodiment, and is basically the same as that in the sub-content distribution system in any one of the first to fourth embodiments. In FIG. 12, the receiving terminal apparatus transmits the request information for sub-content not to the distribution apparatus for sub-content, but to the management apparatus for request information of sub-content list. Further, the management apparatus for request information of sub-content list transmits the request condition information to the

from for broadcast may be transmitted not only to, but also to the distribution apparatus for sub-content, and the distribution apparatus for sub-content calculates the transmission schedule of sub-content based on the amount of the sub-contents included in the request condition information.

The other acquisitions are the same as those in the sub-content distribution system in any one of the first to fourth embodiments, so that descriptions are omitted.

<Brief Description of Effects of Fifth Embodiment>

According to the distribution system for sub-content of the fifth embodiment, it becomes possible to distribute the sub-content in accordance with priority of user.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A sub-content distribution system, comprising:
a broadcasting apparatus, which broadcasts main content relating to sub-content;
a distribution apparatus for sub-content, which distributes sub-content; and
a receiving terminal apparatus for broadcast, wherein
the broadcasting apparatus comprises,
a broadcasting unit for sub-content list data, which broadcasts sub-content list data including identification information of sub-content,
the receiving terminal apparatus for broadcast comprises,
a transmission unit for request information of sub-content, which transmits request information of sub-content based on the identification information of sub-content included in the received sub-content list data, and
an acquisition unit for transmission forenotice information of sub-content, which acquires transmission forenotice information of sub-content in accordance with the request information of sub-content transmitted from the transmission unit for request information of sub-content, and
the distribution apparatus for sub-content comprises,
a calculation unit for transmission schedule of sub-content, which calculates a transmission schedule of sub-content based on amount of the request information of sub-content transmitted from a plurality of receiving terminal apparatuses for broadcast, and
a transmission unit for transmission forenotice information of sub-content, which transmits the transmission forenotice information of sub-content generated based on said calculated transmission schedule of sub-content to the receiving terminal apparatus for broadcast, which has transmitted the request information of sub-content.

2. The sub-content distribution system according to claim 1, wherein
the distribution apparatus for sub-content further comprises,
a transmission unit for sub-content, which carries out transmission of sub-content based on said calculated transmission schedule of sub-content.

3. The sub-content distribution system according to claim 1, wherein
the broadcasting unit for sub-content list data of the broadcasting apparatus further comprises,
broadcasting means during broadcast of program, which broadcasts sub-content list data during broadcast of main content, or immediately after the broadcast of main content, and
the receiving terminal apparatus for broadcast further comprises,
an output unit for list during broadcast of program, which outputs a sub-content list data during output of main content, or immediately after the output of main content.

4. The sub-content distribution system according to claim 1, further comprising:
a transmission apparatus for sub-content list data, which is a substitute for the broadcasting unit for sub-content list data of said broadcasting apparatus, and transmits the sub-content list data to the receiving terminal apparatus for broadcast.

5. The sub-content distribution system according to claim 1, further comprising:
a management apparatus for request information of sub-content list, comprising,
a receiving unit for request information of sub-content, which receives request information of sub-content from a plurality of receiving terminal apparatuses for broadcast, and
a transmission unit for request condition information, which transmits request condition information including amount of the request information of sub-content received by the receiving unit for request information of sub-content.

6. A sub-content distribution method utilizing a sub-content distribution system, which comprises a broadcasting apparatus, which broadcasts main content relating to sub-content, a distribution apparatus for sub-content, which distributes sub-content, and a receiving terminal apparatus for broadcast, the method comprising the steps of:
broadcasting a sub-content list data including identification information of sub-content;
receiving the sub-content list data broadcasted by said step of broadcasting sub-content list data;
transmitting request information of sub-content from a plurality of receiving terminal apparatuses for broadcast based on the identification information of sub-content included in the sub-content list data received by said step of receiving sub-content list data;
acquiring transmission forenotice information of sub-content in accordance with the request information of sub-content transmitted by said step of transmitting request information of sub-content;
calculating a transmission schedule of sub-content based on amount of the request information of sub-content transmitted by said step of transmitting request information of sub-content; and
transmitting the transmission forenotice information of sub-content generated based on the transmission schedule of sub-content calculated by said step of calculating transmission schedule of sub-content to the receiving terminal apparatus for broadcast, which has transmitted the request information of sub-content.

7. The sub-content distribution method according to claim 6, further comprising the step of:
transmitting sub-content based on the transmission schedule of sub-content calculated by said step of calculating transmission schedule of sub-content.

8. The sub-content distribution method according to claim 6, further comprising the step of:
outputting a sub-content list data during output of main content, or immediately after the output of main content from the receiving terminal apparatus for broadcast in cases where the sub-content list data is broadcasted by said step of broadcasting sub-content list data during broadcast of main content, or immediately after the broadcast of main content.

9. The sub-content distribution method according to claim 6, further comprising the step of:
transmitting sub-content list data to the receiving terminal apparatus for broadcast as a substitute for said step of broadcasting sub-content list data.

10. The sub-content distribution method according to claim 6, further comprising the steps of:
receiving request information of sub-content from a plurality of receiving terminal apparatuses for broadcast by the management apparatus for request information of sub-content list; and
transmitting request condition information including amount of the request information of sub-content received by said step of receiving request information of sub-content from said management apparatus for request information of sub-content list to said sub-content distribution apparatus.

11. The sub-content distribution system according to claim 2, wherein
the broadcasting unit for sub-content list data of the broadcasting apparatus further comprises,
broadcasting means during broadcast of program, which broadcasts sub-content list data during broadcast of main content, or immediately after the broadcast of main content, and
the receiving terminal apparatus for broadcast further comprises,
an output unit for list during broadcast of program, which outputs a sub-content list data during output of main content, or immediately after the output of main content.

12. The sub-content distribution system according to claim 2, further comprising:
a transmission apparatus for sub-content list data, which is a substitute for the broadcasting unit for sub-content list data of said broadcasting apparatus, and transmits the sub-content list data to the receiving terminal apparatus for broadcast.

13. The sub-content distribution system according to claim 3, further comprising:
a transmission apparatus for sub-content list data, which is a substitute for the broadcasting unit for sub-content list data of said broadcasting apparatus, and transmits the sub-content list data to the receiving terminal apparatus for broadcast.

14. The sub-content distribution system according to claim 2, further comprising:
a management apparatus for request information of sub-content list, comprising,
a receiving unit for request information of sub-content, which receives request information of sub-content from a plurality of receiving terminal apparatuses for broadcast, and
a transmission unit for request condition information, which transmits request condition information including amount of the request information of sub-content received by the receiving unit for request information of sub-content.

15. The sub-content distribution system according to claim 3, further comprising:
a management apparatus for request information of sub-content list, comprising,
a receiving unit for request information of sub-content, which receives request information of sub-content from a plurality of receiving terminal apparatuses for broadcast, and
a transmission unit for request condition information, which transmits request condition information including amount of the request information of sub-content received by the receiving unit for request information of sub-content.

16. The sub-content distribution system according to claim 4, further comprising:
a management apparatus for request information of sub-content list, comprising,
a receiving unit for request information of sub-content, which receives request information of sub-content from a plurality of receiving terminal apparatuses for broadcast, and
a transmission unit for request condition information, which transmits request condition information including amount of the request information of sub-content received by the receiving unit for request information of sub-content.

17. The sub-content distribution method according to claim 7, further comprising the step of:
outputting a sub-content list data during output of main content, or immediately after the output of main content from the receiving terminal apparatus for broadcast in cases where the sub-content list data is broadcasted by said step of broadcasting sub-content list data during broadcast of main content, or immediately after the broadcast of main content.

18. The sub-content distribution method according to claim 7, further comprising the step of:
transmitting sub-content list data to the receiving terminal apparatus for broadcast as a substitute for said step of broadcasting sub-content list data.

19. The sub-content distribution method according to claim 8, further comprising the step of:
transmitting sub-content list data to the receiving terminal apparatus for broadcast as a substitute for said step of broadcasting sub-content list data.

20. The sub-content distribution method according to claim 7, further comprising the steps of:
receiving request information of sub-content from a plurality of receiving terminal apparatuses for broadcast by the management apparatus for request information of sub-content list; and
transmitting request condition information including amount of the request information of sub-content received by said step of receiving request information of sub-content from said management apparatus for request information of sub-content list to said sub-content distribution apparatus.
